(19) United States
(12) Patent Application Publication
(10) Pub. No.: US 2012/0080992 A1
(43) Pub. Date: Apr. 5, 2012

(54) LED BULB STRUCTURE

(76) Inventor: Chiu-Mao Huang, Sinjhuang City (TW)

(21) Appl. No.: 12/897,345

(22) Filed: Oct. 4, 2010

(51) Int. Cl. H01J 61/52

(52) U.S. Cl. 313/46

(57) ABSTRACT

An LED bulb structure includes a base having a first end and a second end. The first end has a connection section. The second end has a surface section and an extension section substantially perpendicularly protruding from the second end without interfering with the surface section. The extension section has a mount face on which an LED module is disposed and a heat dissipation section disposed on an outer surface of the extension section. a transparent space being defined between the mount face and the surface section. When the LED bulb structure is horizontally locked in a socket on a wall of a building, the projection angle and range of the LED module are modified to enhance lighting efficiency of the LED module.

### FIELD OF THE INVENTION

The present invention relates to an LED bulb structure, and more particularly to an LED bulb structure in which the projection angle of the LED module is modified to enhance lighting efficiency of the LED module.

### BACKGROUND OF THE INVENTION

In comparison with a conventional light bulb, an LED bulb has the advantages of power saving and high durability. Therefore, the LED bulb has higher and higher market share nowadays.

Please refer to FIGS. 1, 2A and 2B. A conventional LED bulb structure 1 includes a heat dissipation base 10 and a transparent shell 12 correspondingly connected with the heat dissipation base 10 to cover the same. The heat dissipation base 10 has a first end proximal to the transparent shell and a second end distal from the transparent shell. Multiple LED chips 13 are arranged on an end face of the first end of the heat dissipation base 10. The heat dissipation base 10 has a heat dissipation section 101 and an electrical connection section 103. The heat dissipation section 101 is disposed around the heat dissipation base 10. A first end of the electrical connection section 103 is connected with the second end of the heat dissipation base 10. A second end of the electrical connection section 103 is locked in a corresponding socket 20 under a ceiling or on a wall 2 (such as a decorative wall) of a building. The electrical connection section 103 has an axis C coinciding with an axis C of the heat dissipation section 101. That is, the axis C of the electrical connection section 103 and the axis C of the heat dissipation section 101 are the same horizontal line.

Please refer to FIG. 2A. The conventional LED bulb is generally mounted under a ceiling 2 for illumination purpose. However, it has become a trend to mount the LED bulb on a decorative wall 2 to provide indirect illumination and visual beautifying effect for indoor or outdoor decoration purpose or meet the requirement of space or height design as shown in FIG. 2B.

Referring to FIG. 2B, in the case that the LED bulb is screwed in the socket 20 and mounted on the decorative wall 2 to provide illumination effect, the LED chips 13 are parallel to the wall face. It is an inherent property of the LED bulb to emit light straightly at a small projection angle such as of about 20 degrees. Therefore, the LED chips 13 in the LED bulb will emit light straightly forward (in a horizontal direction). Under such circumstance, the light emitted from the LED chips 13 can hardly reach the lower side of the decorative wall 2. As a result, the lighting efficiency of the LED bulb is poor as a whole. Also, the projection angle and range of the LED bulb are limited. According to the aforesaid, the conventional LED bulb has the following shortcomings:

1. Poor lighting efficiency;

2. Limited projection angle; and

3. Poor utilization.

### SUMMARY OF THE INVENTION

A primary object of the present invention is to provide an LED bulb structure in which the projection angle and range of the LED module are modified.

A further object of the present invention is to provide the above LED bulb structure, which has enhanced lighting efficiency.

To achieve the above and other objects, the LED bulb structure of the present invention includes a base having a first end and a second end opposite to the first end. The first end has a connection section. The second end has an extension section and a surface section. The extension section substantially perpendicularly protrudes from the second end without interfering with the surface section. The extension section has a mount face on which an LED module is disposed and a heat dissipation section opposite to the mount face. The heat dissipation section is disposed on an outer surface of the extension section. A transparent space is defined between the mount face and the surface section. When the LED bulb structure is locked in a socket on a wall of a building, the projection angle and range of the LED module are modified to enhance lighting efficiency of the LED module.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a conventional LED bulb;

FIG. 2A is a perspective view showing an application of the conventional LED bulb;

FIG. 2B is a perspective view showing another application of the conventional LED bulb;

FIG. 3 is a perspective view of the LED bulb structure of the present invention;

FIG. 3A is a front sectional view of a preferred embodiment of the LED bulb structure of the present invention;

FIG. 3B is a front sectional view of another embodiment of the LED bulb structure of the present invention;

FIG. 4A is a perspective assembled view showing an application of the LED bulb structure of the present invention; and

FIG. 4B is a perspective exploded view showing the application of the LED bulb structure of the present invention.

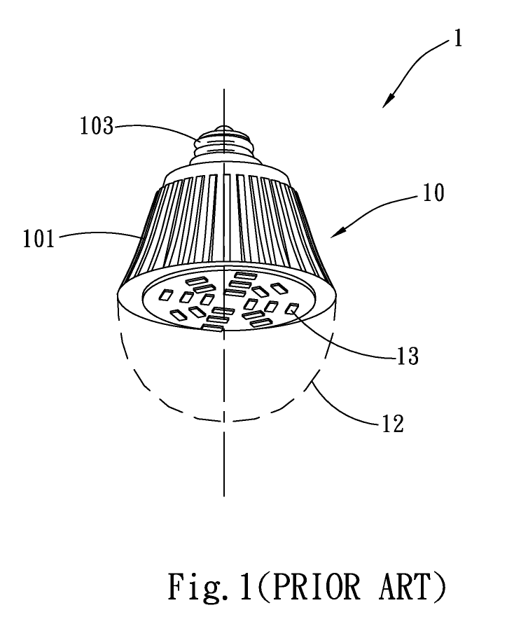

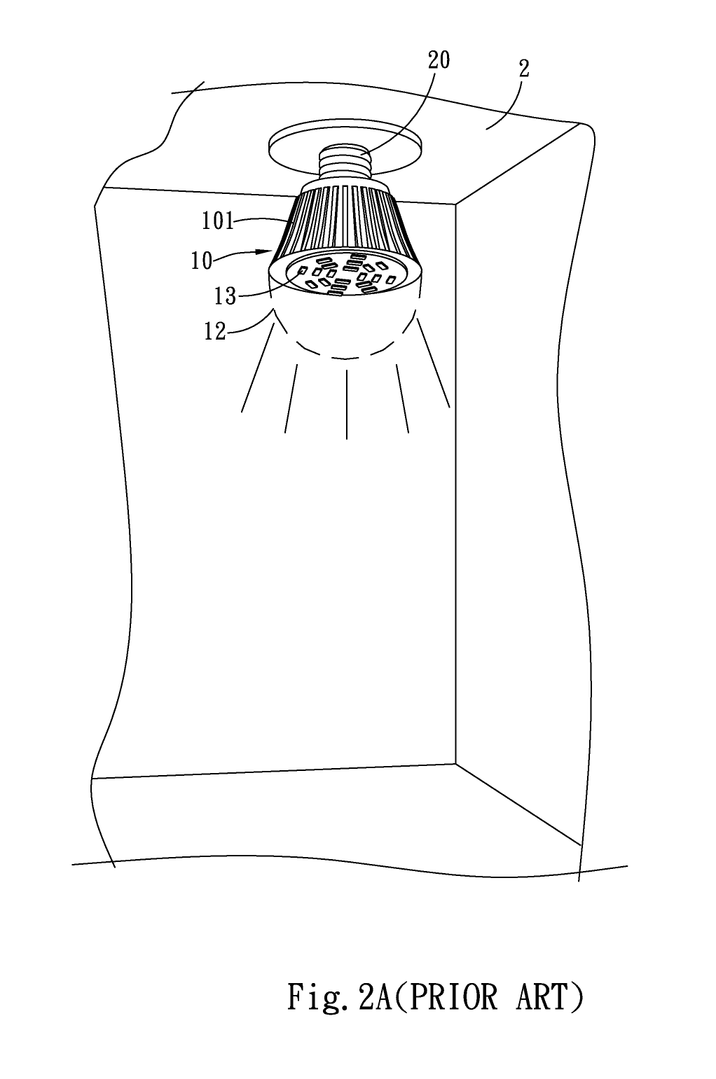

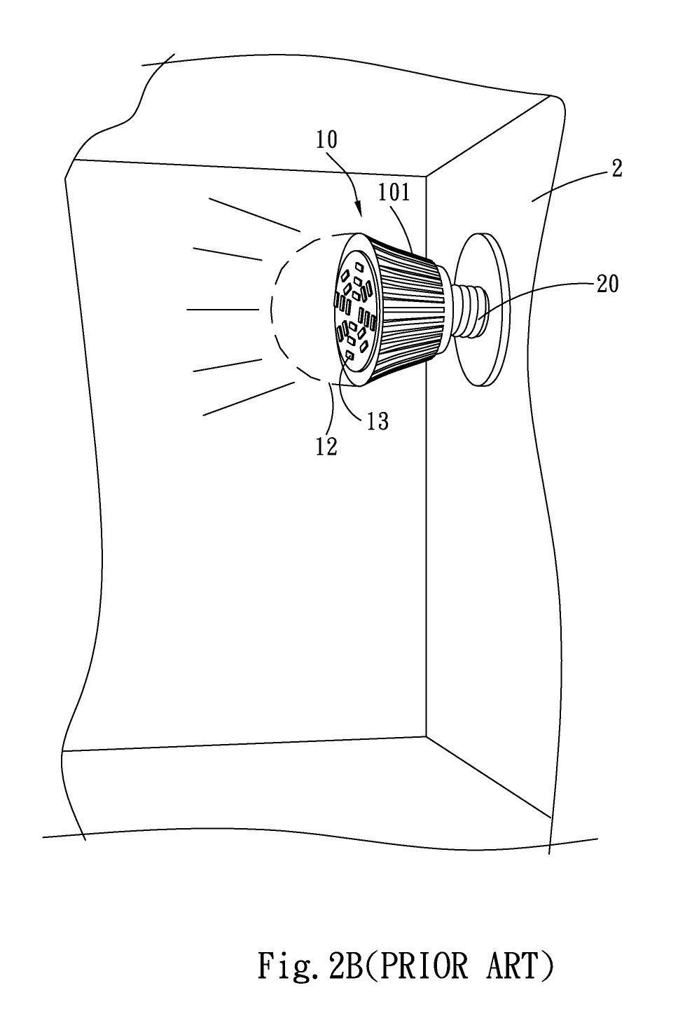

### DETAILED DESCRIPTION OF THE PREFERRED EMBODIMENTS

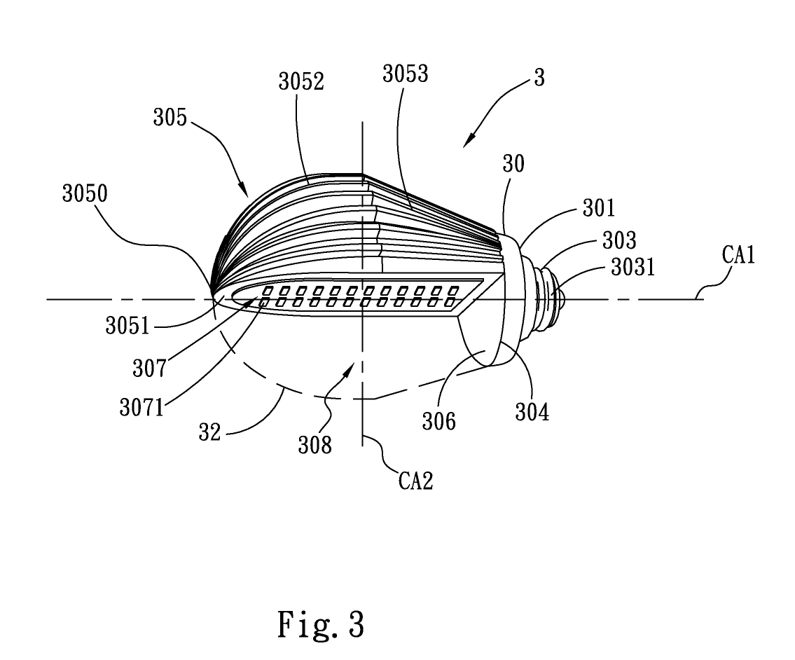

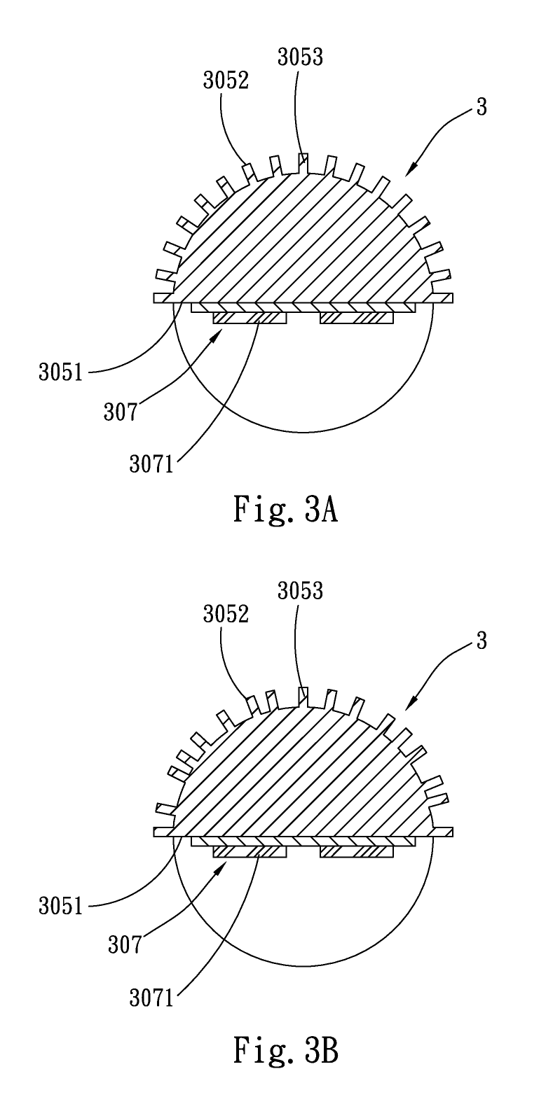

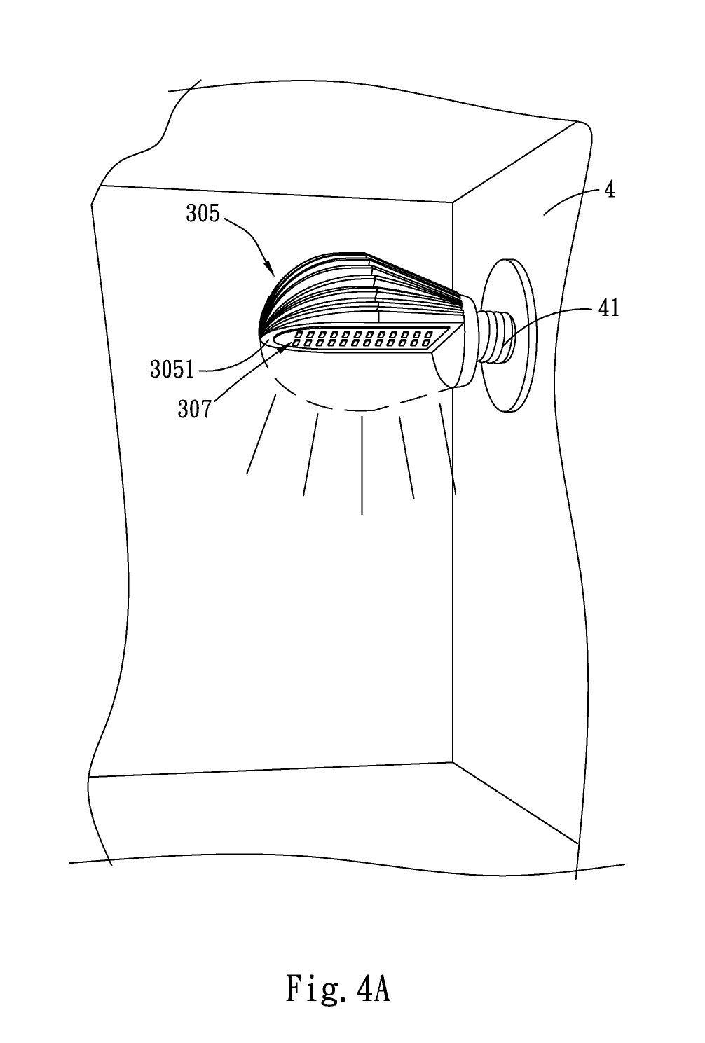

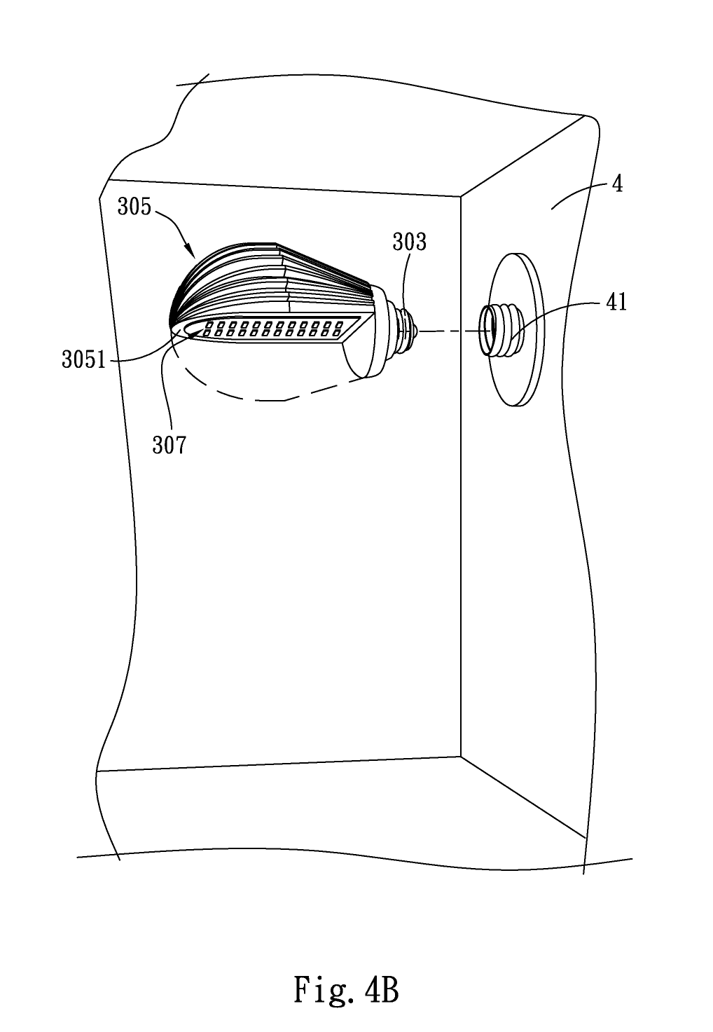

Please refer to FIGS. 3, 4A and 4B. According to a preferred embodiment, the LED bulb structure 3 of the present invention includes a base 30 and a transparent shell 32. The base 30 has a first end 301 and a second end 304 opposite to the first end 301. The first end 301 has a connection section 303, which is an electrical connector. The connection section 303 has a conductive terminal 3031, which can be locked in a socket 41 on a wall 4 (such as a decorative wall) of a building.

The second end 304 has an extension section 305 and a surface section 306. The extension section 305 substantially perpendicularly protrudes from the second end 304 (at an angle smaller than or equal to 90 degrees) without interfering with the surface section 306. In other words, the extension section 305 is a protrusion, which has a free end 3050 extending from the second end 304 in a direction away from the base 30.

The extension section 305 further has a mount face 3051 and a heat dissipation section 3052 opposite to the mount face 3051. An LED module 307 is disposed on the mount face 3051 and electrically connected with the connection section 303. The LED module 307 has multiple LED chips 3071 arranged on the mount face 3051 and positioned in a transparent space 308 defined between the mount face 3051 and the surface section 306.

The connection section 303 has a first axis CA1. The LED module 307 and the mount face 3051 have a second axis CA2 in common. The first axis CA1 of the connection section does not coincide with the second axis CA2 of the LED module 307 and the mount face 3051. That is, the first axis CA1 of the connection section 303 is normal to the second axis CA2 of the LED module 307 and the mount face 3051. Accordingly, the LED module 307 emits light in a non-horizontal direction other than the axis CA1 of the connection section 303. In this case, the projection angle, direction and range of the LED module 307 are modified.

Further referring to FIG. 3, the heat dissipation section 3052 is disposed on an outer surface of the extension section 305. The heat dissipation section 3052 has multiple radiating fins 3053 extending from the free end 3050 of the extension section 305 to the second end 304 along the outer surface of the extension section 305. The radiating fins 3053 are arranged at equal intervals (as shown in FIG. 3A) to form a heat sink or at unequal intervals (as shown in FIG. 3B) to form a heat sink.

The transparent shell 32 correspondingly covers the mount face 3051 and the surface section 306 to enclose the mount face 3051, the LED module 307, the surface section 306 and the transparent space 308. The transparent shell 32 is integrally assembled with the base 30 to form the LED bulb structure 3.

Further referring to FIGS. 3, 4A and 4B, as aforesaid, the first axis CA1 of the connection section 303 is normal to the second axis CA2 of the LED module 307 and the mount face 3051. In this case, when the connection section 303 of the LED bulb is screwed into the socket 41 on the wall 4, the mount face 3051 of the extension section 305 and the LED module 307 thereon are directly oriented to a lower side of the wall 4. It is a property of the LED bulb to emit light straightly. Therefore, the LED module 307 of the LED bulb will directly project light to the lower side of the wall 4. Accordingly, the projection angle and range of the LED module 307 are modified to enhance lighting efficiency of the LED bulb and provide visual beautifying effect.

According to the aforesaid, the second axis CA2 of the mount face 3051 of the extension section 305 and the LED module 307 thereon is normal to the first axis CA1 of the connection section 303. Therefore, when the LED bulb is applied to the wall 4, the LED bulb can provide indirect illumination and visual beautifying effect for indoor or outdoor decoration and meet the requirement of space or height design. Moreover, the projection angle and range of the LED module 307 can be modified to enhance lighting efficiency of the LED module 307.

In conclusion, in comparison with the prior art, the present invention has the following advantages:

1. The projection angle and range of the LED module can be modified; and

2. The lighting efficiency of the LED bulb is enhanced.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

1: An LED bulb structure comprising a base having a first end and a second end opposite to the first end, the structure having a connection section only at the first end, the second end having a surface section, the base further comprises an extension section, the extension section substantially perpendicularly protruding from the second end without intersecting the surface section, the extension section having a mount face on which an LED module is disposed and a heat dissipation section opposite to the mount face, the heat dissipation section being disposed on an outer surface of the extension section, a transparent space being defined between the mount face and the surface section.

2: The LED bulb structure as claimed in claim 1, further comprising a transparent shell, which correspondingly covers the mount face and the surface section to enclose the LED module, the surface section and the transparent space.

3: The LED bulb structure as claimed in claim 2, wherein the extension section is a protrusion, which has a free end extending from the second end in a direction away from the base.

4: The LED bulb structure as claimed in claim 3, wherein the heat dissipation section has multiple radiating fins extending from the free end of the second end.

5: The LED bulb structure as claimed in claim 4, wherein the radiating fins are arranged at equal intervals or unequal intervals to form a heat sink.

6: The LED bulb structure as claimed in claim 1, wherein the connection section is an electrical connector electrically connected with the LED module, the connection section having a conductive terminal, which can be correspondingly locked in a socket.

7: The LED bulb structure as claimed in claim 1, wherein the LED module has multiple LED chips arranged on the mount face.

8: The LED bulb structure as claimed in claim 1, wherein the connection section has a first axis and the LED module and the mount face have a second axis not coinciding with the first axis of the connection section.

9: The LED bulb structure as claimed in claim 1, wherein the connection section has a first axis and the LED module and the mount face have a second axis not coinciding with the first axis of the connection section.
